(19) United States
(12) Patent Application Publication
(10) Pub. No.: US 2011/0199457 A1
(43) Pub. Date: Aug. 18, 2011

(54) THREE-DIMENSIONAL IMAGE PROCESSING DEVICE, TELEVISION RECEIVER, AND THREE-DIMENSIONAL IMAGE PROCESSING METHOD

(75) Inventors: Ritsuo YOSHIDA, Ome-shi (JP); Tsutomu Sakamoto, Fukaya-shi (JP)

(73) Assignee: Kabushiki Kaisha Toshiba, Tokyo (JP)

(21) Appl. No.: 12/976,842

(22) Filed: Dec. 22, 2010

(30) Foreign Application Priority Data
Dec. 28, 2009 (JP) 2009-297101

(51) Int. Cl. H04N 13/00

(52) U.S. Cl. 348/43; 348/E13.074

(57) ABSTRACT

According to one embodiment, a three-dimensional image processing device which includes a separating module configured to input left and right image frames shot at the same timing and each having a frame frequency f, and to provide a left image frame and a right image frame, a first interpolation processing module configured to generate left interpolated image frames of a frame frequency of f×n/2 (where n is an integer equal to or greater than 2) at equal time intervals corresponding to elapse of time, based on the left image frames, and a second interpolation processing module configured to generate right interpolated image frames of a frame frequency of f×n/2 corresponding to an intermediate time between the left interpolated image frames, based on the right image frames.

### CROSS-REFERENCE TO RELATED APPLICATIONS

This application is based upon and claims the benefit of priority from Japanese Patent Application No. 2009-297101, filed Dec. 28, 2009; the entire contents of which are incorporated herein by reference.

### FIELD

Embodiments described herein relate generally to image processing, in particular, to a three-dimensional image processing device, a TV receiver, and a three-dimensional image processing method capable of providing the user with a three-dimensional image.

### BACKGROUND

Recently, according to development in image display techniques, three-dimensional image processing systems capable of displaying three-dimensional images to the user have been proposed. One of such three-dimensional image processing systems for allowing the user to recognize three-dimensional images is a system that uses shutter glasses.

In the three-dimensional image display system using the shutter glasses, a left-eye image and a right-eye image, between which parallax occurs, are displayed at different timings on a display device. By controlling the liquid crystal shutter of the shutter glasses between open and closed states, only the left-eye image is shown to the left eye of the user, and only the right-eye image is shown to the right eye. Thereby, the image displayed on the display device is recognized by the user as three-dimensional.

When such a technique is applied to a display device of a system of providing display by line scanning, such as a liquid-crystal display, the previous and next frame images concurrently exist one above the other during line scanning, interposing the selected scanning line on the display screen as a boundary. Further, this boundary constantly moves from top down during the line scanning. That is, since a portion of the left-eye image and a portion of the right-eye image are simultaneously displayed, three-dimensional images may not be precisely recognized by the user.

A conventional technique has been disclosed for solving such a problem. A device of this conventional technique comprises an image display module (such as a liquid crystal panel), a writing module (such as a driving circuit of a liquid crystal panel) capable of writing frame image data into the image display module by means of line scanning, an image data supply module configured to supply image data of a frequency obtained by multiplying the frequency of the image signal by a factor of n (i.e., converted at nth speed), and a light source module (such as a back light) capable of irradiating the image display module with a source light.

According to such a conventional technique, the right-eye image data and the left-eye image data included in written image data are alternately displayed on the image display module every first period (period of the left or right image frame) set according to the frequency of images. In this case, the image data is written into the image display module in a second period, which is 1/n of the first period (where n is a natural number equal to or greater than 2). The backlight is turned off in the second period (during writing) included in the first period, and turned on in a third period following the second period.

That is, according to this conventional technique, the backlight is turned off, and data on one left or right image frame is written into the display device in a time period equal to or less than 1/n (where n is a natural number equal to or greater than 2) of each left or right image frame period, and the backlight is turned on in the remaining period of said one image frame. As a result thereof, a portion of the left-eye image and a portion of the right-eye image will not be simultaneously displayed, and a three-dimensional image is precisely recognized by the observer.

In the above-described conventional display method, however, the image presented to each of the left eye and the right eye has a frame frequency same as that of the input image. Further, image presentation and shielding are alternately carried out at the same time width, for example. This causes flicker, which becomes a big problem especially in a bright image. Further, since the left image and the right image shot at the same time are presented to the viewer of the three-dimensional image screen with deviated by half the time (period of the left or right image frame) of the frame period, the moving image looks unnatural to the viewer.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 illustrates an example of an outline of a three-dimensional image processing system according to an embodiment of the present invention;

FIG. 2 illustrates an example of a shooting system of a left-eye image and a right-eye image according to an embodiment of the present invention;

FIG. 3 is a block diagram illustrating an exemplary inner configuration of a three-dimensional image processing system according to an embodiment of the present invention;

FIG. 4 illustrates a procedure of processing an input image frame and generating an interpolated image frame according to a first embodiment;

FIG. 5 illustrates a display method of a conventional technique;

FIG. 6 illustrates an interpolation process according to the second embodiment of the present invention;

FIG. 7 illustrates an interpolation process according to the third embodiment of the present invention;

FIG. 8 illustrates an interpolation process according to the fourth embodiment of the present invention; and

FIG. 9 illustrates an interpolation process according to a fifth embodiment of the present invention.

### DETAILED DESCRIPTION

Various embodiments will be described hereinafter. A three-dimensional image processing device according to the embodiments is capable of displaying three-dimensional images such that the left and right images agree with the actual elapse of time and flicker does not occur, by increasing the frame frequency of the image displayed in each of the left and right eyes using a frame interpolation process. In general, according to one embodiment of the invention, there is provided a three-dimensional image processing device, comprising: a separating module configured to input left and right image frames shot at the same timing and each having a frame frequency f, and to provide a left image frame and a right image frame by separating the left and right image frames; a first interpolation processing module configured to generate left interpolated image frames of a frame frequency of f×n/2 (where n is an integer equal to or greater than 2) at equal time intervals corresponding to elapse of time through a frame interpolation process, based on the left image frames provided by the separating module; a second interpolation processing module configured to generate right interpolated image frames of a frame frequency of f×n/2 (where n is an integer equal to or greater than 2) corresponding to an intermediate time between the left interpolated image frames through a frame interpolation process, based on the right image frames provided by the separating module; and a multiplexing module configured to alternately arrange and multiplex left and right interpolated image frames generated by the first and second interpolation processing modules, and generate a display signal to be displayed at a frame frequency of f×n.

Hereinafter, an embodiment of the present invention will be described with reference to the accompanying drawings.

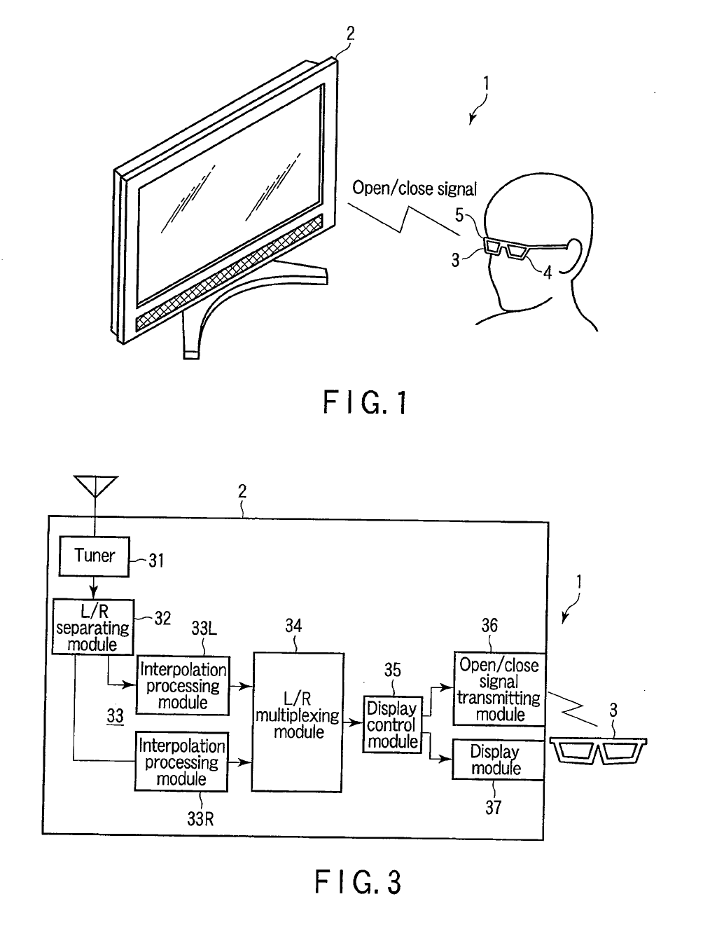

FIG. 1 illustrates an example of an outer view of a three-dimensional image processing system 1 according to the present embodiment.

The three-dimensional image processing system 1 includes a TV receiver 2 and shutter glasses 3. The TV receiver 2 is shown as an example of a three-dimensional image processing device of the present invention. By wearing the shutter glasses 3 and viewing the image displayed on the TV receiver 2, the user can recognize the image as a three-dimensional image.

Usually, a person sees an object with the left and right eyes located in different positions, and a parallax exists between the image seen by the left eye and the image seen by the right eye. By combining the image seen by the left eye and the image seen by the right eye, between which a parallax exists, a person can recognize the object that the person is seeing as three-dimensional.

The TV receiver 2 is a digital television, for example, and is capable of projecting three-dimensional images to the user wearing the shutter glasses 3 by alternately displaying a left-eye image and a right-eye image, between which a parallax exists. Further, as will be described later, the TV receiver 2 is also equipped with a function of generating a new image frame as an interpolated image frame based on the received image signal for three-dimensional image display.

The shutter glasses 3 include a left-eye lens 4 and a right-eye lens 5. A liquid crystal shutter capable of shielding light is provided in each of the left-eye lens 4 and the right-eye lens 5. Each of the shutters is opened and closed at different timings based on a shutter open/close signal received from the TV receiver 2, and a three-dimensional image is conveyed to the user to see the left-eye image. For example, when the left-eye image is displayed on the TV receiver 2, the shutter glasses 3 set the shutter of the right-eye lens 5 to a closed state based on the open/close signal from the TV receiver 2, and lets only the left eye (one portion) of the user. When the right-eye image is displayed, on the other hand, the shutter of the left-eye lens 4 is set to a closed state, and lets only the right eye (the other portion) of the user to see the right-eye image.

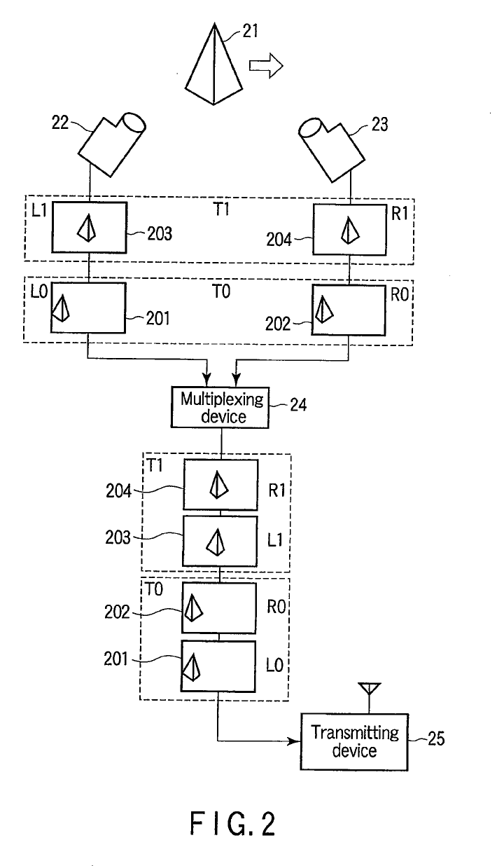

FIG. 2 illustrates an exemplary shooting system of shooting a left-eye image and a right-eye image. In FIG. 2, an object 21, a left-eye shooting device 22, a right-eye imaging device 23, a multiplexing device 24, a transmitting device 25, and image frames 201-204 are shown.

The object 21 is a target of imaging of the left-eye imaging device 22 and the right-eye imaging device 23, and is a movable body that moves in the arrow direction (right direction) shown in FIG. 2. The left-eye imaging device 22 and the shooting time of the right-eye imaging device 23 are imaging devices designed to image the object 21, and image the left-eye image and the right-eye image, respectively. Further, the shooting time of the left-eye imaging device 22 and the shooting time of the right-eye imaging device 23 are set at the same timing (i.e., imaging is performed at the same time).

The image frames 201-204 are image frames imaged by the left-eye imaging device 22 and the right-eye imaging device 23. The image frame (L₀) 201 and the image frame (R₀) 202 are image frames imaged by the left-eye imaging device 22 and the right-eye imaging device 23, respectively. The image frame (L₁) 203 and the image frame (R₁) 203 are image frames imaged by the left-eye imaging device 22 and the right-eye imaging device 23, respectively, at a time T1. The image frames 201-204 imaged by the left-eye imaging device 22 and the right-eye imaging device 23 are transmitted to the multiplexing device 24.

The multiplexing device 24 has a function of multiplexing the left-eye image frame and the right-eye image frame received in parallel from the left-eye imaging device 22 and the right-eye imaging device 23, respectively, into continuous serial data, and outputting it to the transmitting device 25. In the present embodiment, the multiplexing device 24 performs multiplexing of the image frame so as to transmit the image frame imaged earlier in the temporal order first. The image frames shot at the same time are arranged such that the left-eye image comes first and the right-eye image follows after, multiplexed, and output to the transmitting device 25.

The transmitting device 25 encodes digital data of the received image frame, and transmits the encoded data as a broadcast signal to the receiving device.

FIG. 3 is a block diagram illustrating an example of an inner configuration of a three-dimensional image processing system according to the present embodiment.

As shown in FIG. 3, the TV receiver (three-dimensional image processing device) 2 includes a tuner 31, an L/R separating module 32, an interpolation processing module 33 (33L, 33R), an L/R multiplexing module 34, a display control module 35, an open/close signal transmitting module 36, and a display module 37, and is capable of receiving the broadcast signal transmitted from the transmitting device 25 and providing the user with a three-dimensional image.

The tuner 31 selects, demodulates, and decodes a broadcast signal transmitted by the transmitting device 25 shown in FIG. 2 and received by an antenna, and generates an image signal (image data) that can be displayed on the TV receiver 2.

The L/R separator 32 has a function of separating the image signal from the tuner 31 into a left-eye image and a right-eye image. The separated left-eye image and the right-eye image are transmitted to the interpolation processing module 33.

The interpolation processing device 33L receives a left-eye image from the L/R separator 32, and obtains a left-eye interpolated image corresponding to a time between the times when the image frames are shot, by performing a calculation based on the continuous left-eye image frames. The interpolation process refers to a process of comparing two image frames, obtaining a motion vector in the image frames, and generating an image frame at the intermediate point in time between the times when the two image frames are shot, based on the obtained motion vector. The interpolation process (frame interpolation process) is described in detail in Jpn. Pat. Appln. KOKAI Publication No. 2008-067222.

The interpolation processing module 33R receives a right-eye image from the L/R separating module 32, and obtains a right-eye interpolated image corresponding to a time between the times when the image frames are shot, by performing a calculation based on the continuous right-eye image frames. The L/R multiplexing module 34 arranges the left-eye image and the right-eye image received from the interpolation processing module 33 in temporal axis, multiplexes them, and transmit them to the display control module 35.

The display control module 35 has a function of converting image data received from the L/R multiplexing module 34 into data appropriate for display, and displaying the converted data on the display module 37. In this case, the display control module 35 performs control of the display time of the image frame in the image data. Further, the display control module 35 transmits an open/close signal for letting the shutter glasses 3 to open or close the shutter in synchronization with switching of the left and right image frames to the open/close signal transmitting module 36.

The open/close signal transmitting module 36 has a function of transmitting an open/close signal instructing the shutter glasses 3 to open/close the shutter as an infrared ray, upon receipt of the open/close signal of the shutter glasses 3 from the display control module 35. In the present embodiment, the open/close signal is transmitted by infrared rays, but the present invention is not limited thereto and other wireless transmission systems capable of transmitting open/close signals may be used. Further, the TV receiver 2 and the shutter glasses 3 may be connected via a wired cable via which the shutter glasses can transmit and receive signals. The shutter glasses open and close the liquid crystal shutter based on the open/close signal received from the open/close signal transmitting module 36.

### First Embodiment

Hereinafter the operation of the three-dimensional image processing system 1 according to an embodiment of the present invention will be described.

In the three-dimensional image processing system 1, the input left and right images of each frame frequency f are converted into image frames of each frame frequency f×n/2 (where n is an integer equal to or greater than 2) by a frame interpolation process of the interpolation processing module 33L, 33R, and the converted left and right images are alternately arranged and displayed on the display module at the frame frequency of f×n.

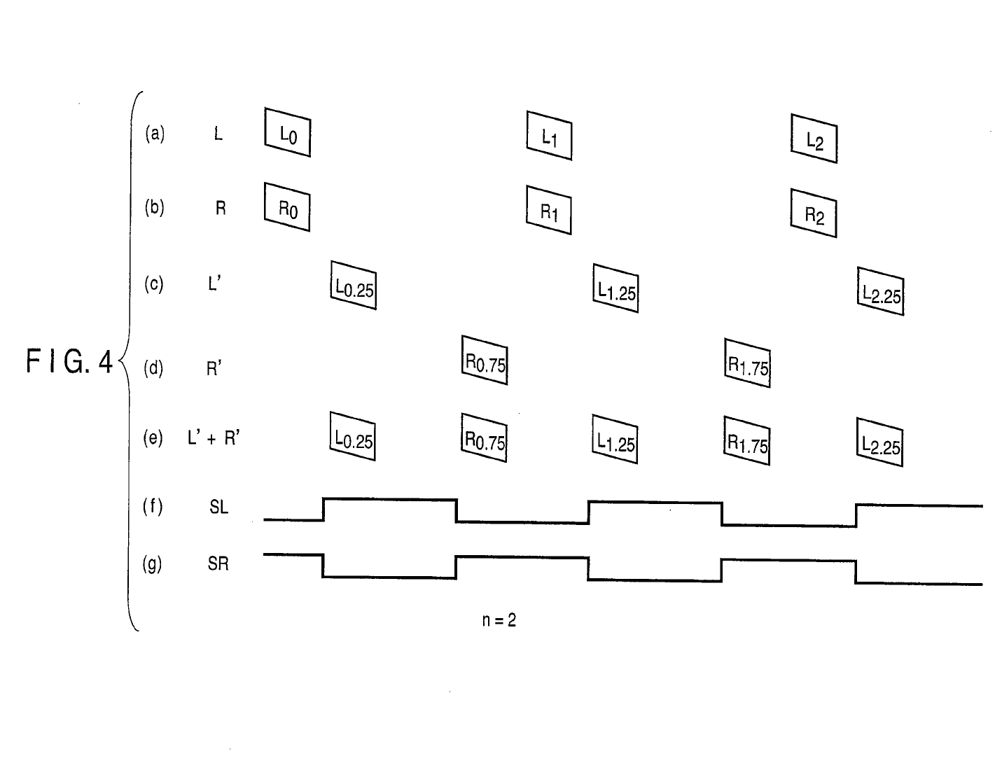

First, a description will be made with regard to the operation of the case where the three-dimensional image frame frequency is f, i.e., the three-dimensional image frame frequency is the same as the input frame frequency f (where n=2), according to the first embodiment. In this embodiment, the total number of the output three-dimensional image frames per unit time and the total number of the left and right image frames per unit time are equal. FIG. 4 illustrates an interpolation process of processing an input image frame and generating a three-dimensional image frame, according to the first embodiment of the present invention.

In FIGS. 4 (a) and 4 (b), L and R refer to the left and right images of the frame frequency f input to the interpolation processing module 33L, 33R, respectively. The suffix indicates the frame number in time direction. That is, the left images are input to the interpolation processing module 33L in the order of L₀, L₁, L₂, L₃, . . . and the right images are input to the interpolation processing module 33R in the order of R₀, R₁, R₂, R₃, . . . .

As shown in FIG. 4 (c), the interpolation processing module 33L obtains left interpolated images L′ arranged at temporally equal intervals by performing a process of generating an interpolated image L_{0.25} of a time close to L₀ through an interpolation process by dividing the interval between L₀ and L₁ into 4, and generating an interpolated image L_{1.25} of a time close to L1 by dividing the interval between L₁ and L₂, and so on.

On the other hand, the interpolation processing module 33R obtains right interpolated images R′ arranged at temporally equal intervals by generating an interpolated image R_{0.75} of a time close to R₁ through an interpolation process by dividing the interval between R₀ and R₁ into 4, and then obtains an interpolated image R_{1.75} of a time close to R₂ through an interpolation process by dividing the interval between R₁ and R₂ into 4, and so on. The multiplexing module 34 multiplexes the interpolated images L′, R′ as shown in FIG. 4 (e), and outputs a multiplexed image L′+R′ on the display module 37.

FIG. 4 (f) is an open/close signal SL of the left-eye shutter L, and FIG. 4(g) is an open/close signal SR for the right-eye shutter R. As a result thereof, the user recognizes an image L_{0.25} in the left eye and an image R_{0.75} in the right eye, an image L_{1.25} in the left eye and an image R_{1.75} in the right eye, and so on. The duty of the open/close signal is 50% in the present embodiment, but a value smaller than 50% is adopted when crosstalk becomes a problem between the left and right images. When a liquid crystal display is used as a display device, in order to reduce crosstalk, the duty of the backlight may be reduced.

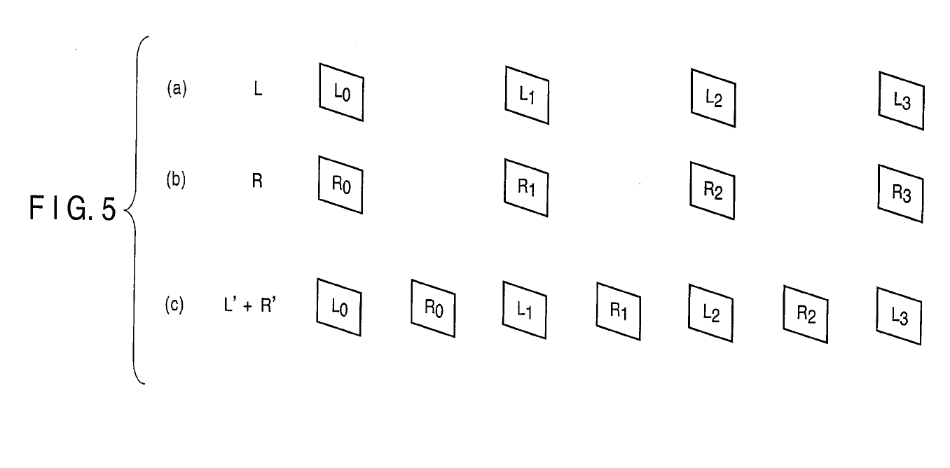

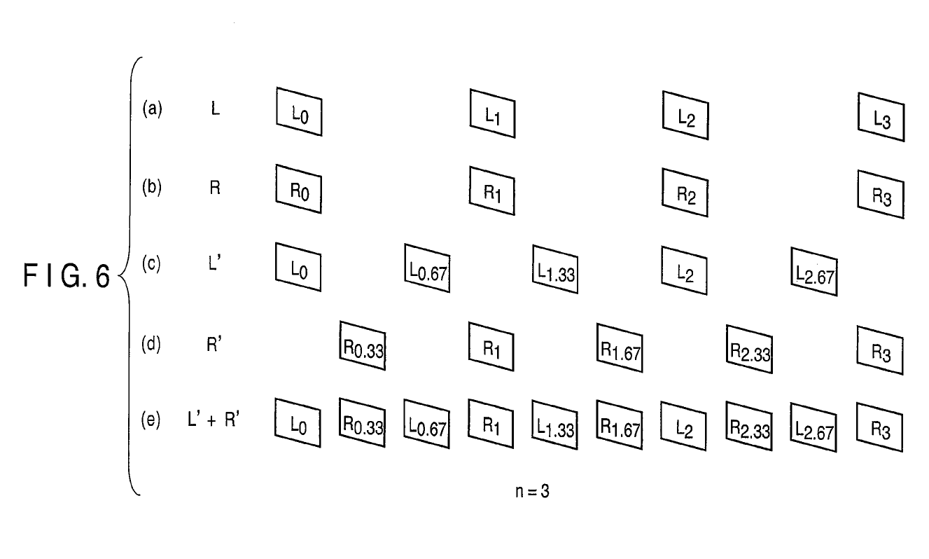

FIG. 5 shows a display method of the conventional technique as a comparison with the present embodiment. In FIGS. 5(a) and 5(b), L and R refer to the input left and right images, respectively, of the frame frequency f, and FIG. 5(c) illustrates a multiplexed image L′+R′. The multiplexed image L′+R′ looks unnatural to the viewer as a moving image, since the images (such as L₀ and R₀) shot at the same time are displayed, in spite of deviation in time of half the time of the frame frequency between the left and right images. In the present embodiment, however, as shown in FIG. 4, the multiplexed image L′+R′ is presented as an interpolated image that agrees with the actual elapse of time, and therefore does not look unnatural to the viewer.

### Second Embodiment

Next, a description will be made with regard to the operation of generating an interpolated image of the interpolated image frame frequency of 3f/2, i.e., generating an interpolated image by causing interpolation processing modules 33L, 33R to multiply an interpolated image frame frequency by a factor of 1.5, according to the second embodiment. In the present embodiment, the total number of output three-dimensional image frames per unit time is 3/2 times of the total number of left and right input image frames per unit time.

FIG. 6 illustrates an interpolation process according to the second embodiment of the present invention.

FIGS. 6 (a) and 6 (b) illustrate the input left and right images L and R, respectively, of the frame frequency f, and FIGS. 6 (c) and 6 (d) illustrate interpolated images L′ and R′, respectively, and FIG. 6 (e) illustrates a multiplexed image L′+R′.

As shown in FIG. 6 (c), the interpolation processing module 33L converts a left image L into a left interpolated image L′ of 1.5 times of the frame frequency, through a frame interpolation process. In this case, the interval between L₀ and L₁ is divided into 3 and an interpolated image L_{0.67} of a time close to L₁ is generated through an interpolation process, and then the interval between L₁ and L₂ is divided into 3 and an interpolated image L_{1.33} of a time close to L₁ is obtained through an interpolation process. Thereby, left interpolated images L′ arranged at temporally equal intervals are obtained.

On the other hand, the interpolation processing module 33R converts a right image R into a right interpolated image R of 1.5 times of the frame frequency through a frame interpolation process. In this case, the interval between R₀ and R₁ is divided into 3 to generate an interpolated image R_{0.33} of a time close to R₀ through an interpolation process, and then the interval between R₁ and R₂ is divided into 3 to obtain an interpolated image R_{1.67} of a time close to R₂. Thereby, right images R′ arranged at temporally equal intervals are obtained.

When the temporal position to be interpolated by the left and right images is deviated by ⅓ of the frame period of the input image, as in the interpolation procedure of the present embodiment, the left image L′ and the right image R′ will be images that are not overlapping and arranged at temporally equal intervals. Accordingly, left and right images (multiplexed images) L′+R′ arranged at temporally equal intervals are obtained y alternately arranging the left interpolated image L′ and the right interpolated image R′. Further, in the present embodiment, the image information of the input image frame can be directly used as image data for display.

Three-dimensional display is provided by displaying the left and right images L′+R′ and, in synchronization thereto, for example, performing control so as to project an image only to the left eye when a left image is displayed and only to the right eye when the right image is displayed, using glasses configured to control the left and right eye portions between a transmissive state and a non-transmissive state, as shown in FIGS. 4(f) and 4(g).

A comparison will be made between the display method of the conventional technique shown in FIG. 5 and the method of the present embodiment. Compared to the conventional technique, the present embodiment is capable of providing display with no or sufficiently reduced flicker, which has conventionally occurred, since the frame frequency of the present embodiment is 1.5 times of the conventional technique. Further, since the images shot at the same time are displayed in spite of deviation in time of half the frame period between the left and right images in the conventional technique, the moving image looks unnatural to the user. In the present embodiment, since the left and right images vary in agreement with the actual elapse of time, even a moving image does not look unnatural to the user at all.

### Third Embodiment

Next, the operation of generating an interpolated image by obtaining an interpolated image frame frequency of 2f (where n=4), i.e., by making an interpolated image frame frequency double the input frame frequency f, according to the third embodiment. In this embodiment, the total number of output three-dimensional image frames per unit time is double the total number of left and right input image frames per unit time.

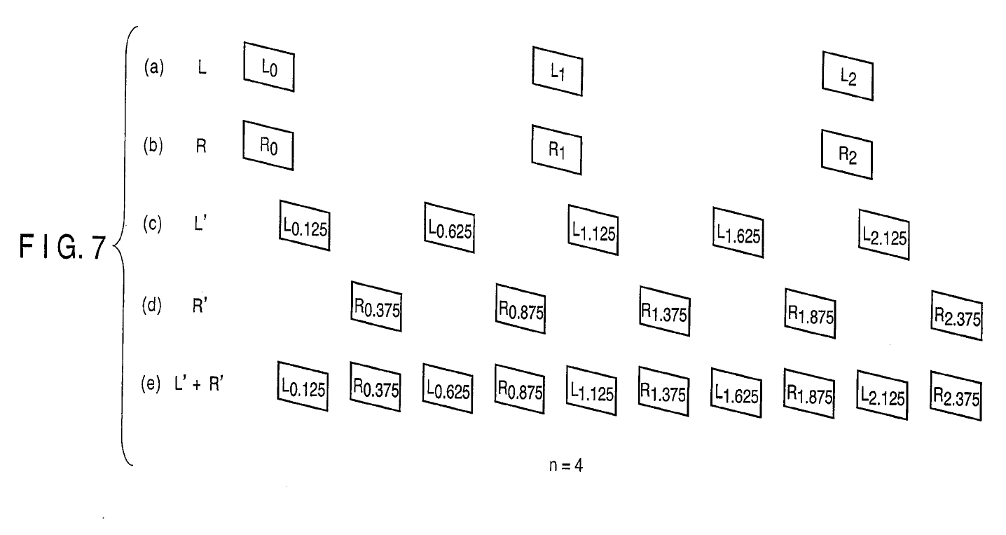

FIG. 7 illustrates an interpolation process according to the third embodiment of the present invention. FIGS. 7 (a) and 7 (b) illustrate input left and right images L and R, respectively, of a frame frequency f, FIGS. 7 (c) and 7 (d) illustrate interpolated images L′ and R′, respectively, and FIG. 7 (e) illustrates multiplexed images L′+R′, respectively.

As shown in FIG. 7 (c), the interpolation processing module 33L converts an input left image shown in FIG. 7 (a) into a left interpolated image L′ of double the frame frequency through a frame interpolation process. In this case, an interpolated image L_{0.125} of a time closest to L₀ and L_{0.625} of the fifth division are generated through an interpolation process by dividing the interval between L₀ and L₁ into 8, and an interpolated image L_{1.125} of a time closest to L₁ and L_{1.625} of the fifth division are obtained through an interpolation process by dividing the interval between L₁ and L₂ into 8, and thereby left interpolated images L′ arranged at temporally equal intervals are obtained.

On the other hand, the interpolation processing module 33R converts an input right image R of FIG. 7 (b) into a right interpolated image R′ of double the frame frequency through a frame interpolation process. In this case, the interval between R0 and R1 is divided into 8 and R_{0.375} of the third division and R0.875 of the 7th division are generated through an interpolation process, and then the interval between R1 and R2 are divided into 8 and R_{1.375} of the third division from R1 and R_{1.875} of the seventh division are obtained through an interpolation process. Thereby, left interpolated images R′ arranged at temporally equal intervals are obtained.

In the interpolation process according to the third embodiment, since the multiplexed image frame frequency 4f is further higher than 3f of the second embodiment, flicker is further reduced.

### Fourth Embodiment

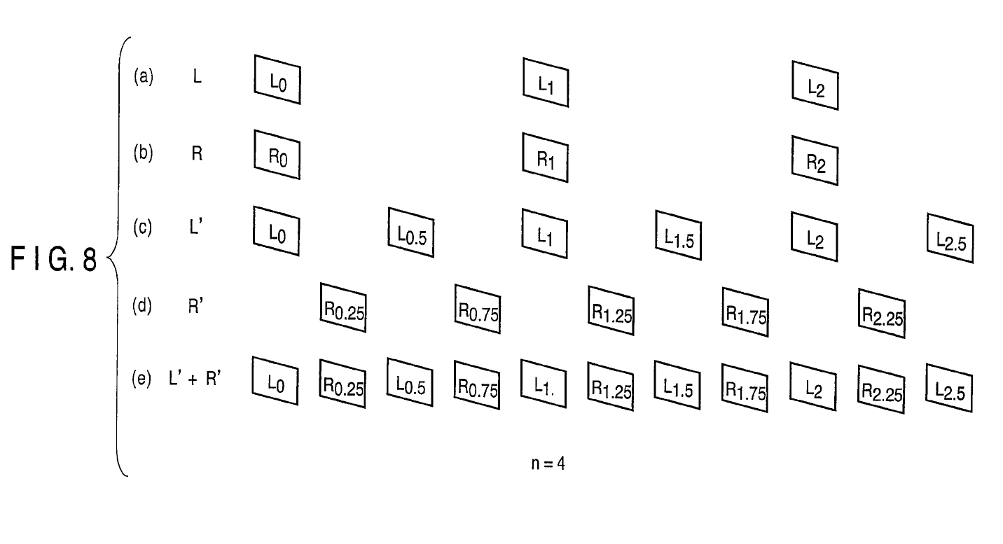

FIG. 8 illustrates an interpolation process according to a fourth embodiment of the present invention. In this embodiment, the frequency of the multiplexed image frame is the same as that of the third embodiment, but the timing at which the interpolated image is generated is different.

That is, as shown in FIG. 8 (c), the interpolation processing module 33L converts the left image L into a left interpolated image L′ of double the frame frequency through a frame interpolation process. In this case, the interval between L₀ and L₁ is divided into 2 and an interpolated image L_{0.5} of an intermediate time is generated through an interpolation process, and then the interval between L₁ and L₂ is divided into 2 and an interpolated image L_{1.5} of an intermediate time is obtained through an interpolation process. Thereby, left interpolated images L′ arranged at temporally equal intervals are obtained.

On the other hand, the interpolation processing module 33R converts the right image R into a right interpolated image R′ of double the frame frequency through a frame interpolation process. In this case, the interval between R₀ and R₁ is divided into 4 and R_{0.25} of a time close to R₀ and R_{0.75} of a time close to R₁ are generated through an interpolation process, and then the interval between R₁ and R₂ is divided into 4 and R_{1.25} of a time close to R₁ and R_{1.75} of a time close to R₂ are obtained through an interpolation process. Thereby, left interpolated images R′ arranged at temporally equal intervals are obtained.

In this fourth embodiment, the input left image frames L (L₀, L₁, . . . ) are directly included in the multiplexed image frames, without being processed. Accordingly, the amount of calculation of the interpolated image process is reduced in the present embodiment, compared to the third embodiment.

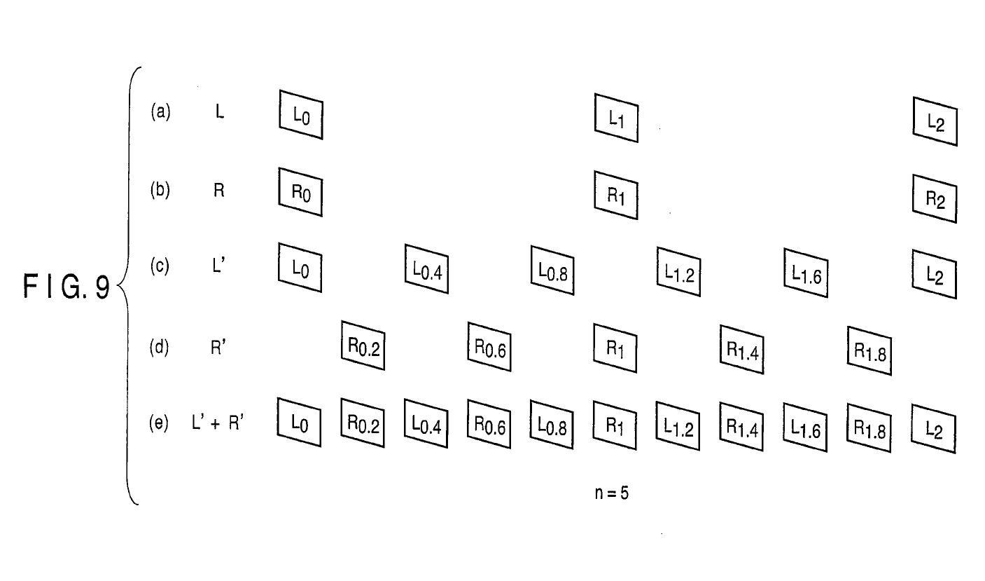

FIG. 9 shows an operation of generating an interpolated image by setting the multiplexed image frame frequency 5f/2 (where n=5), i.e., by making the interpolated image frame frequency 2.5 times of the input frame frequency f. The same operation principles and effects apply, including the cases where n is equal to or greater than 6.

In the above-described embodiments, the input image frame (actual image) can be used as a multiplexed image frame when n of the interpolated image frame frequency (f×n/2) is an odd number equal to or greater than 3, as shown in FIGS. 6 and 9, and the left and right interpolation processing modules 33L and 33R perform the exactly same process on the input image frame, and thereby the interpolated process will be simplified as a whole. In particular, when n is 3 as shown in FIG. 6, flicker is practically resolved in a three-dimensional image presented by the multiplexed image, and the interpolated processing rate can be embodied at a relatively low rate as well.

As described above, according to the embodiment of the present invention, a three-dimensional display device capable of displaying left and right images in a three-dimensional manner in agreement with the actual elapse of time (with natural operation) without generating flicker.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image processing device, comprising:
a separating module configured to input left and right image frames shot at the same timing and each having a frame frequency f, and to provide a left image frame and a right image frame by separating the left and right image frames;
a first interpolation processing module configured to generate left interpolated image frames of a frame frequency of f×n/2 (where n is an integer equal to or greater than 2) at equal time intervals corresponding to elapse of time through a frame interpolation process, based on the left image frames provided by the separating module;
a second interpolation processing module configured to generate right interpolated image frames of a frame frequency of f×n/2 (where n is an integer equal to or greater than 2) corresponding to an intermediate time between the left interpolated image frames through a frame interpolation process, based on the right image frames provided by the separating module; and
a multiplexing module configured to alternately arrange and multiplex left and right interpolated image frames generated by the first and second interpolation processing modules, and generate a display signal to be displayed at a frame frequency of f×n.

2. The three-dimensional image processing device according to claim 1, wherein n in the frame frequency f×n/2 is an odd number equal to or greater than 3.

3. The three-dimensional image processing device according to claim 1, wherein n in the frame frequency f×n/2 is 3, and the multiplexing module arranges the interpolated image frame deviated from one of the input left and right image frames by ⅓ of the period of the input image frames.

4. The three-dimensional image processing device according to 2, wherein the multiplexing module further comprises a transmitting module configured to transmit a control signal to glasses designed to control left and right eye portions between a transmissive state and a non-transmissive state, in synchronization with display of the left and right image frames.

5. The three-dimensional image processing device according to 3, wherein the multiplexing module further comprises a transmitting module configured to transmit a control signal to glasses designed to control left and right eye portions between a transmissive state and a non-transmissive state, in synchronization with display of the left and right image frames.

6. A TV receiver, comprising:
a tuner configured to receive, select, and demodulate a broadcast signal, and provide image information;
a separating module configured to input left and right image frames included in the image information from the tuner, shot at the same timing, and each having a frame frequency f, and to provide a left image frame and a right image frame by separating the left and right image frames;
a first interpolation processing module configured to generate a left interpolated image frame having a frame frequency of f×n/2 (where n is an integer equal to or greater than 2) using a frame interpolation process and arranged at equal time intervals corresponding to elapse of time, based on the left image frames provided by the separating module;
a second interpolation processing module configured to generate a right interpolated image frame having a frame frequency of f×n/2 (where n is an integer equal to or greater than 2), and corresponding to an intermediate time between the left interpolated image frames through a frame interpolation process, based on the right image frames provided by the separating module;
a multiplexing module configured to alternately arrange and multiplex left and right interpolated image frames generated by the first and second interpolation processing modules and generate a display signal to be displayed at the frame frequency of f×n; and
a display module configured to alternately display the left and right images based on the display signal generated by the multiplexing module.

7. The TV receiver according to claim 6, wherein n in the frame frequency f×n/2 is an odd number equal to or greater than 3.

8. The TV receiver according to claim 7, further comprising a transmitting module configured to transmit a transmittance/non-transmittance control signal to glasses configured to control left and right eye portions between a transmissive state and a non-transmissive state in synchronization with display of the left and right image frames.

9. A three-dimensional image processing method, comprising:
inputting left and right image frames shot at the same timing and each having a frame frequency f;
providing a left image frame and a right image frame by separating the left and right image frames;
generating a left interpolated image frame having a frame frequency of f×n/2 (where n is an integer equal to or greater than 2), corresponding to elapse of time, and arranged at equal time intervals through a frame interpolation process, based on the provided left image frames;
generating a right interpolated image frame having a frame frequency of f×n/2 (where n is an integer equal to or greater than 2) and corresponding to an intermediate time between the left interpolated image frames through a frame interpolation process, based on the provided right image frames; and
multiplexing and alternately arranging the generated left and right interpolated image frames, and generating a display signal to be displayed at the frame frequency of f×n/2.
